(19) United States
(12) Patent Application Publication
(10) Pub. No.: US 2017/0039565 A1
(43) Pub. Date: Feb. 9, 2017

(54) METHOD AND SYSTEM FOR TRANSFERRING FUNDS DATA

(71) Applicant: Plemicor Holdings Canada Inc., Montreal (CA)

(72) Inventors: Garo DERMOSESSIAN, Montreal (CA); Raphael DERMOSESSIAN, Montreal (CA); Alex DERMOSESSIAN, Montreal (CA)

(21) Appl. No.: 15/304,588

(22) PCT Filed: Apr. 22, 2015
(86) PCT No.: PCT/CA2015/000266

§ 371 Date: Oct. 17, 2016

Related U.S. Application Data
(63) Continuation-in-part of application No. 14/308,089, filed on Jun. 18, 2014.
(60) Provisional application No. 61/982,391, filed on Apr. 22, 2014.

(51) Int. Cl. G06Q 20/40; G06Q 20/10

(52) U.S. Cl. CPC G06Q 20/407; G06Q 20/10; G06Q 20/403; G06Q 20/405

(57) ABSTRACT

A method for transferring, exchanging and storing funds data between payment cards, merchant terminals and an operator database. The method includes: creating a table of transaction data with a unique time stamp for each transaction; calculating trust numbers for each transaction; summing all the trust numbers within a given accumulation period thereby defining a trust account amount; calculating a balance amount from the trust account amount; creating a table of sequenced transactions according to their respective unique time stamp; selecting a subset of the sequenced transactions from a first transaction being the most cotemporal to a given time and ending with a cut off transaction; creating a table of the subset of the sequenced transactions; respectively adding the corresponding numbers representative of the value of the transaction to the amount of funds associated to the payment cards which correspond to the transactions in the subset of the sequenced transactions.

### BACKGROUND

(a) Field

The subject matter disclosed generally relates to methods and systems for electronic transactions. More specifically, it relates to systems and methods transferring, exchanging and storing funds data between entities involved in the electronic transactions.

(b) Related Prior Art

Various and different methods and systems that provide incentives to buyers and customers (aka purchasers) exist in the context of performing a buying transaction from merchants/sellers of different commodities and services. Most of them provide points or rewards of different types that are credited to a buyer's or purchaser's account when a purchase is performed from a pool of merchants/sellers of different commodities and services. These points and rewards are preset values related to the amount of the purchase and/or are provided by a random process of selection.

Some of the technical problems involved in improving such systems is providing timely information concerning credits/refunds to user, determining and selecting to which payment cards used for performing the transactions credits/funds should be attributed, determining the structure of the tables of data to be used, distinguishinging each transaction (i.e., uniquely identifying each transactions to discriminate them) to be able to perform a selection amongst them, etc.

The present disclosure proposes novelties and improvements in this field.

### SUMMARY

In the present description, the terms hereunder can be understood according to and in the context of the definitions given hereto.

Operator data and processing server (ODPS-DPS) or Operator data communication and processing server (ODCPS-DCPS): The server connected to a secure data communication and processing network which is controlled, managed and configured by the operator of the purchase refund system (method) described herein. See, for example, FIG. 6, item 610.

Data initiation terminal (aka Merchant terminal): any device with a user interface that is capable of accepting payment from a buyer (i.e., a transaction between the buyer and a seller for goods or services) and accessing a communication network to communicate the details of the buying-purchasing transaction to another computing entity (e.g., a server from a banking institution and an operator data and processing server). The data initiation terminal/merchant terminal may also include web interfaces/pages used for performing online transactions; i.e., ecommerce. See, for example, FIG. 6, item 612.

Payment card: a card that can be utilized by a user and accepted by a merchant terminal for a purchase. In the context of this description, the payment card has the capacity to store electronically at least a user ID or any other means to provide electronically information about a purchase account associated to a user. In other instances, the payment card has the capacity to store purchase transaction information and related data.

Cotemporal: occurring at the same time. Hence, “events which are the most cotemporal” refers to events which are closest to each other on the scale of time.

Unique time stamp: a time indicator associated to each transaction and having a precision which is sufficiently such that each transaction has one and only one time stamp associated thereto. The precision therefore depends on the number of transaction occurring within a given period. The greater the number of transactions with a given period, the higher the required precision will be to determine the most cotemporal events; i.e., additional digits after the decimal point to handle increased numbers of transactions accurately. For example, in some embodiments, millisecond precision will be sufficient while in others microseconds will be required. Yet other embodiments will require nanosecond precision. An example of the use of the unique time stamp is further described herein in accordance with FIGS. 8, 9 and 10.

Unique key: in database relational modeling and implementation, a unique key is a set of zero, one or more attributes, the value(s) of which are guaranteed to be unique for each tuple (row) in a relation. The value or combination of values of unique key attributes for any tuple cannot be duplicated for any other tuple in that relation. When more than one column is combined to form a unique key, their combined value is used to access each row and maintain uniqueness. Such an example is a concatenated key; that is, a key made from more than one attribute joined together as a single key.

Network access device: any device with computing capability and a user interface that is capable of accessing a communication network; e.g., smart phone, tablet, phablet, laptop, desktop, etc. See, for example, FIG. 6, item 616.

Payment card: a card associated with a purchasing account and used at data initiation terminal in the process of completing a purchase transaction.

Owner of a purchasing account: a person or other entity which is permitted to be registered in the purchase refund system described herein.

Buyer/purchaser: a person who performs a purchase transaction at a data initiation terminal/merchant terminal. The buyer can be the same entity as the owner of a purchasing account or another authorized entity performing the purchase in the name of the owner of a purchasing account.

Merchant/seller: an institution or a person who provides the sales of commodities, goods and/or services in his possession and/or custody who is the owner of an account (aka a selling account) in a financial institution which authorizes the sale of these commodities, goods and/or services through a financial network of services compatible with the purchase transaction data communication and processing server within the financial institution and in the same manner linked to the operator data communication and processing server for the purpose of implementing the purchase refund method and system described herein.

Operator/Developer: the entity which controls, manages and configures the purchase refund system described herein.

Purchasing account: Data stored in a database which is associated to a unique identifier associated to the owner of a purchasing account. The data associated to the purchasing account may include, but is not limited to, the name of a person (the owner of the purchasing account), an account number, the address and other particulars associated to and identifying the owner, a password to access the purchasing account, a list of transactions associated to the purchasing account, banking information associated with the owner of the purchasing account, the amount of monetary funds available for making purchases, a Personal Identification Number (PIN) used for performing transactions using monetary funds available in the purchasing account, etc.

Eligible: adjective used to qualify an entity (e.g., a buyer/purchaser, merchant/seller, a purchasing account, etc.) which is registered in the purchase refund system/method.

Refund/Payback: a uniquely identified amount of monetary fund credited to a purchasing account for a uniquely identified purchase transaction.

Selling account: Data stored in a database which is associated to a unique identifier associated to a merchant/seller. The data associated to the selling account may include, but is not limited to, the name of a person (the owner of the selling account, aka the merchant/seller), an account number, the address and other particulars associated to and identifying the merchant/seller, a password to access the selling account, a list of transactions associated to the selling account, banking information associated with the owner of the selling account, etc.

Merchant's/seller's monetary earnings: an amount of monetary funds credited to the selling account relating to a purchase transaction.

Purchase/transaction: a uniquely identified transaction for the acquisition of commodities, goods, services, gifts, investments, etc. involving the exchange of financial funds (aka monetary funds) between the purchasing account of an owner and the selling account of a merchant and/or a seller registered with a financial institution. The purchase transaction must be compatible with a financial institution (or financial institutions) agreeable to both the owner of the purchasing account/buyer and the merchant/seller selling account.

Monetary funds: any payment form, such as a currency, accepted by a merchant for performing a purchase.

Purchase price: the amount of monetary funds required to complete a purchase transaction.

Specific time: the time at which a purchase transaction is made.

Time stamp: an identification of the specific time. The time stamp is made by the operator data and processing server using an international recognized standard for time.

Pool of funds (aka TRUST): the total value of the monetary deposits collected by the accumulation of fees for the transactions made during a given accumulation period. According to an embodiment, the pool of funds (trust) is accumulated in a trust account in an operator database associated to and managed by the operator data and processing server.

Fees (aka trust number): a portion of the purchase price of a purchase transaction collected for deposit in the TRUST.

Given accumulation period: a period, fixed by the operator of the system, during which portions of the purchase price are received/accumulated in the pool of funds.

Given occasions: special times of celebration, such as Independence Day, Thanksgiving Day, Valentine's day, Boxing Day, and other special occasions and holidays.

Certain percentage points: a proportion (%) of the total monetary value of the purchase transaction which is deducted from the selling account of the merchant/seller producing the fees for deposit in the TRUST.

Total refund amount (aka BALANCE or balance amount): a portion of the pool of funds which is reserved for refunds to purchasing accounts.

First portion of the total refund amount: a percentage of the total refund amount.

Second portion of the total refund amount: a percentage of the total refund amount different from or equal to the first portion of the total refund amount.

Given refund time (aka given time): a time, selected by the operator, from which transactions are ordered according to their time stamp for determining a refund.

First refund time (aka first time): a time selected by the operator during which a portion of the refund is diffused/credited to eligible buyers according to an embodiment.

Second refund time (aka second time): a time selected by the operator different from the first refund time during which another portion of the refund is diffused/credited to eligible buyers according to an embodiment.

Forward time order: an order which is used to arrange the transactions sequentially according to their time stamp where the less recent transaction is first and the most recent transaction is last.

Backward time order: an order which is used to arrange the transactions sequentially according to their time stamp where the most recent transaction is first and the less recent transaction is last.

According to an embodiment, there is provided a method for transferring funds data related to transactions performed using payment cards at merchant terminals, each one of the payment cards having associated thereto a card ID, a payment card account and an amount of funds available for performing transactions. The method is implemented on an operator data and processing server which performs the following steps:

creating a table of transaction data in an operator database, the transaction data resulting from the use of a plurality of the payment cards at merchant terminals in a transaction which generates the transaction data including, for each use, a transaction ID, the card ID, a number representative of the value of the transaction and a unique time stamp representative of a specific time at which the use took place, wherein the use takes place within a given accumulation period;
calculating trust numbers by applying a percentage that is less than 100% to each number representative of the value of the transaction;
summing all the trust numbers within the given accumulation period thereby defining a trust account amount;
calculating a balance amount by applying a percentage that less than 100% to the trust account amount;
creating a table of sequenced transactions by transaction ID in the operator database, the sequenced transactions being ordered according to their respective unique time stamp within the given accumulation period;
selecting a subset of the sequenced transactions by transaction ID, the subset being selected starting from a first transaction in the sequenced transactions, the first transaction being the most cotemporal to a given time, and ending with a cut off transaction which is the transaction where a sum of each number representative of the value of the transactions, for the transactions between and including the first and at least a portion of the cut off transaction, is equal to or more than the balance amount;
creating a table of the subset of the sequenced transactions in the operator database, the table of the subset of the sequenced transactions comprising the transaction ID and a corresponding number representative of the value of transactions for each transaction of the subset of the sequenced transactions;
respectively adding each corresponding number representative of the value of the transaction to the amount of funds associated to the payment cards which correspond to the transactions in the subset of the sequenced transactions.

According to an aspect, the selecting of the subset comprises selecting sequenced transactions according to at least one of:

a forward time order of the transactions; and
a backward time order of the transactions.

According to an aspect, the given time comprises a first time and a second time, wherein a first portion of the balance amount is attributed to a period starting from the first time and a second portion of the balance amount is attributed to a period starting from the second time.

According to an aspect, a first portion of the balance amount is used in the adding step from the first time according to a forward time order and a second portion of the balance amount is used in the adding step from the second time according to a backward time order.

According to an aspect, the first time corresponds to a beginning of the given accumulation period and the second time corresponds to an end of the given accumulation period.

According to an aspect, the first portion of the balance amount and the second portion of the balance amount are equal.

According to an aspect, the method further comprises remotely accessing, for each one of the payment cards, the payment card account for recording and validating the amount of funds available for performing transactions.

According to an aspect, the method further comprises adding the trust account amount to a trust account, the trust account being separate and distinct from the payment card account and being inaccessible by a user having access to the payment card account.

According to an aspect, the method further comprises, before adding the corresponding numbers representative of the value of the transaction to the amount of funds associated to the payment cards, identifying, based on the transaction ID in the table of transaction data, the respective card Ds and the amount of funds available for performing transactions associated to the transaction ID.

According to an aspect, the method further comprises receiving from a plurality of the merchant terminals the transaction data over a secure communication network.

According to an aspect, the method further comprises associating the respective card IDs to respective users having previously associated an address of respective computing devices to the respective users and sending a notification to the respective computing devices advising the respective users that the adding the corresponding numbers representative of the value of the transactions to the amount of funds associated to the payment cards took place.

According to an embodiment, there is provided a method for providing refunds to eligible purchasing accounts, in which monetary funds are respectively held, for purchases made at respective purchase prices at respective merchant terminals at respective specific times to which are associated respective time stamps, the method comprising:
at an operator data and processing server, receiving a portion of the respective purchase prices for purchases made during a given accumulation period using the plurality of eligible purchasing accounts, in a pool of funds defined as a trust, wherein the portion of the respective purchase prices is less than the respective purchase prices, wherein the given accumulation period comprises multiples or fractions of hours during one calendar day; and
the operator data and processing server selecting, from the purchases made, the refunds to be credited from the trust to the eligible purchasing accounts based on the respective time stamps, wherein the trust comprises funds for fully refunding the purchase price of at least one of the purchases starting from a given refund time within the given accumulation period, wherein the refunds are for use for other purchases without restrictions, and further wherein the selecting, from purchases made, results in fully refunding a number of purchases which is less than the total number of purchases made.

According to an aspect, the method further comprises determining a total refund amount, defined as a balance, as being at least a portion of the funds in the trust, wherein the purchases are sequenced according to the respective time stamps associated thereto thereby defining sequenced purchases and further wherein the selecting the refunds comprises selecting the refunds to eligible purchasing accounts for the sequenced purchases starting from a given refund time comprised within the given accumulation period until the balance is completely diffused.

According to an aspect, the method further comprises using the operator data and processing server for crediting the refunds from the balance to the eligible purchasing accounts.

According to an aspect, the selecting the refunds comprises selecting the refunds to eligible purchasing accounts for the sequenced purchases starting from a given refund time until the balance is completely diffused according to at least one of:

a forward time order of the purchases; and

a backward time order of the purchases.

According to an aspect, the given refund time comprises a first refund time and a second refund time, wherein a first portion of the balance is determined from the first refund time and a second portion of the balance is determined from the second refund time.

According to an aspect, a first portion of the balance is determined from the first refund time according to a forward time order and a second portion of the balance is determined from the second refund time according to a backward time order.

According to an aspect, the first refund time corresponds to a beginning of the given accumulation period and the second refund time corresponds to an end of the given accumulation period.

According to an aspect, the first portion of the balance and the second portion of the balance are equal.

According to an aspect, the selecting the refunds comprises selecting the refunds to eligible purchasing accounts which are one of:

equal to the purchases; or

on given occasions, a multiple of the purchases.

According to an aspect, the method further comprises creating eligible purchasing accounts and attributing an owner to a respective one of the eligible purchasing accounts.

According to an aspect, the method further comprises sending a confirmation to a network access device used that a refund is credited to the eligible purchasing account associated with the network access device.

According to an aspect, the selecting the refunds comprises selecting a one shot or surprise refund on a given occasion.

According to an aspect, the method further comprises crediting the refunds from the trust to the eligible purchasing account.

According to an embodiment, there is provided an operator data and processing server for providing refunds to eligible purchasing accounts, in which monetary funds are held, for purchases made at respective purchase prices at respective merchant terminals at respective specific times to which are associated respective time stamps, the operator data and processing server comprising:
a memory for storing instructions; and
a processor in communication with the memory, the processor for executing the instructions, wherein the instructions comprise the steps of:
   receiving a portion of the respective purchase prices for purchases made during a given accumulation period using the plurality of eligible purchasing accounts, in a pool of funds defined as a trust, wherein the portion of the respective purchase prices is less than the respective purchase prices, wherein the given accumulation period comprises multiples or fractions of hours during one calendar day; and
   selecting, from the purchases made, the refunds to be credited from the trust to the eligible purchasing accounts based on the respective time stamps, wherein the trust comprises funds for fully refunding the purchase price of at least one of the purchases starting from a given refund time within the given accumulation period, wherein the refunds are for use for other purchases without restrictions, and further wherein the selecting, from purchases made, results in fully refunding a number of purchases which is less than the total number of purchases made.

According to an embodiment, there is provided an operator data and processing server for transferring funds data related to transactions performed using payment cards at merchant terminals, each one of the payment cards having associated thereto a card ID, a payment card account and an amount of funds available for performing transactions, the operator data and processing server comprising:
a memory for storing instructions;
an operator database; and
a processor in communication with the memory, the processor for executing the instructions, wherein the instructions comprise the steps of:
   creating a table of transaction data in the operator database, the transaction data resulting from the use of a plurality of the payment cards at merchant terminals in a transaction which generates the transaction data including, for each use, a transaction ID, the card ID, a number representative of the value of the transaction and a unique time stamp representative of a specific time at which the use took place, wherein the use takes place within a given accumulation period;
   calculating trust numbers by applying a percentage that is less than 100% to each number representative of the value of the transaction;
   summing all the trust numbers within the given accumulation period thereby defining a trust account amount;
   calculating a balance amount by applying a percentage that less than 100% to the trust account amount;
   creating a table of sequenced transactions by transaction ID in the operator database, the sequenced transactions being ordered according to their respective unique time stamp within the given accumulation period;
   selecting a subset of the sequenced transactions by transaction ID, the subset being selected starting from a first transaction in the sequenced transactions, the first transaction being the most cotemporal to a given time, and ending with a cut off transaction which is the transaction where a sum of each number representative of the value of the transactions, for the transactions between and including the first and at least a portion of the cut off transaction, is equal to or more than the balance amount;
   creating a table of the subset of the sequenced transactions in the operator database, the table of the subset of the sequenced transactions comprising the transaction ID and a corresponding number representative of the value of transactions for each transaction of the subset of the sequenced transactions;
   respectively adding each corresponding number representative of the value of the transaction to the amount of funds associated to the payment cards which correspond to the transactions in the subset of the sequenced transactions.

According to an embodiment, there is disclosed a method for providing a refund to an eligible purchasing account, in which monetary funds are held, for a purchase made at a purchase price at a specific time to which is associated a time stamp. The method comprises receiving a portion of the purchase price in a pool of funds defined as a trust; calculating a balance to be a difference between the trust and costs; and determining the refund to be transferred from the balance to the eligible purchasing account based on the time stamp, the refund fully covering the value of the purchase price available in the balance or, on given occasions, a multiple of the purchase price.

According to an aspect, the presently disclosed embodiments enhance and promote business sales and revenues by providing attractive and appealing rewards, refunds and stimulus.

According to an aspect, the present disclosure encompasses an application method and system which regulates the refund/payback concept and function through any available scientific and/or industrial technology and implements the refund/payback transactions to eligible buyers/purchasers conforming to certain defined algorithms applicable to different times, seasons, occasions, holidays, events and the like.

According to an embodiment, there is provided a method for providing a refund to an eligible purchasing account, in which monetary funds are held, for a purchase made at a purchase price at a specific time to which is associated a time stamp, the method comprising: at an operator data and processing server, receiving a portion of the purchase price in a pool of funds defined as a trust; and the operator data and processing server determining the refund to be transferred from the trust to the eligible purchasing account based on the time stamp, the refund covering at least a part of the purchase price or a multiple of the purchase price.

According to an aspect, the eligible purchasing account comprises a plurality of eligible purchasing accounts.

According to an aspect, receiving in the trust comprises receiving a portion of the purchase price of at least a portion of purchases made during a given accumulation period using the plurality of eligible purchasing accounts.

According to an aspect, the method further comprises determining a total refund amount, defined as a balance, as being at least a portion of the funds in the trust.

According to an aspect, the purchases are sequenced according to the time stamp associated thereto thereby defining sequenced purchases.

According to an aspect, the determining the refund comprises determining refunds to eligible purchasing accounts for the sequenced purchases starting from a given refund time comprised within the given accumulation period until the balance is completely diffused.

According to an aspect, the determining the refund comprises determining refunds to eligible purchasing accounts for the sequenced purchases starting from a given refund time until the balance is completely diffused according to at least one of:
a forward time order of the purchases; and
a backward time order of the purchases.

According to an aspect, the given refund time comprises a first refund time and a second refund time, wherein a first portion of the balance is determined from the first refund time and a second portion of the balance is determined from the second refund time.

According to an aspect, a first portion of the balance is determined from the first refund time according to a forward time order and a second portion of the balance is determined from the second refund time according to a backward time order.

According to an aspect, the first refund time corresponds to a beginning of the given accumulation period and the second refund time corresponds to an end of the given accumulation period.

According to an aspect, the first portion of the balance and the second portion of the balance are equal.

According to an aspect, the determining the refund comprises determining refunds to eligible purchasing accounts which are one of: equal to the purchase; or, on given occasions, a multiple of the purchase.

According to an aspect, the method further comprises making the purchase at a merchant terminal.

According to an aspect, the method further comprises creating eligible purchasing accounts and attributing an owner to a respective one of the eligible purchasing accounts.

According to an aspect, the method further comprises sending a confirmation to a network access device used that the refund are credited to the eligible purchasing account associated with the network access device.

According to an aspect, the determining the refund comprises determining a one shot or surprise refund on a given occasion.

According to an aspect, the method further comprises transferring the refund from the trust to the eligible purchasing account.

According to an embodiment, there is provided an operator data and processing server for providing a refund to an eligible purchasing account, in which monetary funds are held, for a purchase made at a purchase price at a specific time to which is associated a time stamp, the operator data and processing server comprising:
a memory for storing instructions; and
a processor in communication with the memory, the processor for executing the instructions, wherein the instructions comprise the steps of: receiving a portion of the purchase price in a pool of funds defined as a trust; and determining the refund to be transferred from the trust to the eligible purchasing account based on the time stamp, the refund covering at least a part of the purchase price or, on given occasions, a multiple of the purchase price.

According to an embodiment, there is provided a method for providing refunds to eligible purchasing accounts, in which monetary funds are respectively held, for purchases made at respective purchase prices at respective merchant terminals at respective specific times to which are associated respective time stamps, the method comprising: at an operator data and processing server, receiving a portion of the respective purchase prices for purchases made during a given accumulation period using the plurality of eligible purchasing accounts, in a pool of funds defined as a trust; and the operator data and processing server determining the refunds to be credited from the trust to the eligible purchasing accounts based on the respective time stamps, the refunds fully covering respective purchase prices or, on given occasions, multiples thereof, wherein the refunds are for use in other purchases without restrictions on using the refund at the respective merchant terminal where the purchase eligible for refund was made.

According to an aspect, the method further comprises determining a total refund amount, defined as a balance, as being at least a portion of the funds in the trust, wherein the purchases are sequenced according to the respective time stamps associated thereto thereby defining sequenced purchases and further wherein the determining the refund comprises determining refunds to eligible purchasing accounts for the sequenced purchases starting from a given refund time comprised within the given accumulation period until the balance is completely diffused.

According to an aspect, the method further comprises using the operator data and processing server for crediting the refunds from the balance to the eligible purchasing accounts.

According to an embodiment, the methods and systems described herein incorporate modifications and possible variants of the refund concept which are evident to those skilled in the art.

### BRIEF DESCRIPTION OF THE DRAWINGS

Further features and advantages of the present disclosure will become apparent from the following detailed description, taken in combination with the appended drawings, in which:

FIG. 1 is a flowchart diagram showing a process for a merchant's program registration, in accordance with an embodiment;

FIG. 2 is a flowchart diagram showing a process for a buyer's program registration, in accordance with an embodiment;

FIG. 3 is a flowchart diagram showing a process for a buyer's deposit of monetary funds in his purchasing account, in accordance with an embodiment;

FIG. 4 is a flowchart diagram showing a process for a buyer's purchase transaction, in accordance with an embodiment;

FIG. 5 is a flowchart diagram showing a process for a refund of monetary funds, in accordance with an embodiment;

FIG. 6 is a block diagram of a purchase refund system, in accordance with an embodiment;

FIG. 7 is a flow chart of a method of transferring funds data between payment cards, merchant terminals and an operator database, in accordance with an embodiment;

FIG. 8 is a table of transaction data created in the operator database, in accordance with an embodiment;

FIG. 9 is a table sequenced transactions created in the operator database, in accordance with an embodiment; and

FIG. 10 is a table of a subset of the sequenced transactions created in the operator database, in accordance with an embodiment.

It will be noted that throughout the appended drawings, like features are identified by like reference numerals.

### DETAILED DESCRIPTION

The present description proposes a system and method to enhance sales, by providing a full refund or a multiple of the value of a purchase transaction, to eligible buyers/owners from selling accounts, thru the use of a program, which is executed in selected time intervals on a daily basis or otherwise. Alternatively, the program, or algorithm, can be executed in multiples or fractions of an hour during a calendar day within geographical (time) zones on a given territory (e.g., the USA). In other embodiments, it would be applied on a world-wide basis.

Based on simple market economics, the method is presented in the following paragraphs.

The market's (economics) simplest theory is the availability of a supply and a demand. The basic interest of any purchaser/buyer is to get benefit of his purchases, whether in the form of monetary funds, goods, commodities, services, bonuses, rewards, cash back, loyalty points, points for air mileage, and points for purchasing gas being common examples of this fact. The basic interest of the merchant/seller is to increase (in quantity and value) his sales and revenues.

The mediums of credit-debit, online, e-commerce and/or similar payment methods available in the prior art, except cash, charge certain fees, which the buyer ends up paying and in some applications getting the benefits of his transaction in the form of rewards, points and few cash-back percentage points applied on a selected pool of merchants/sellers and not on all purchases but on some selected groups, services and/or commodities.

An objective of this program is to provide the opportunity of a refund that fully covers the value of the purchase price and, in particular embodiments, even refunds that can cover the multiples of the purchase price. The refund objective is in the form of a monetary refund and will encourage the buyer to use this medium more than the presently available refund services as explained above.

The direct consequence of this advantage, i.e., monetary refund, will enhance the sales at an outlet/merchant/seller/point of sale using this facility, as compared to those who do not provide it. Consequently, the basic theory of supply and demand will be energized.

### Application Example

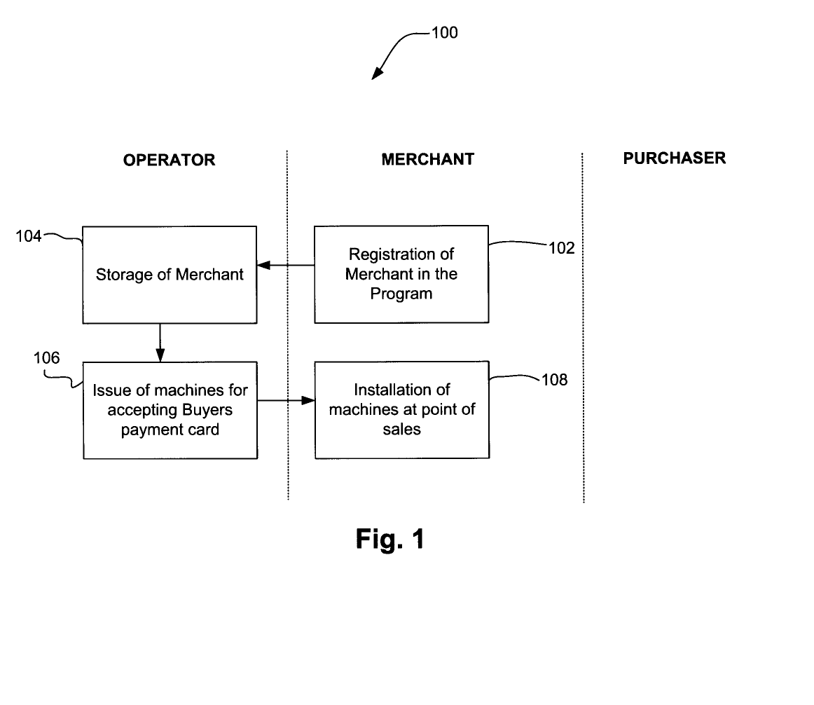

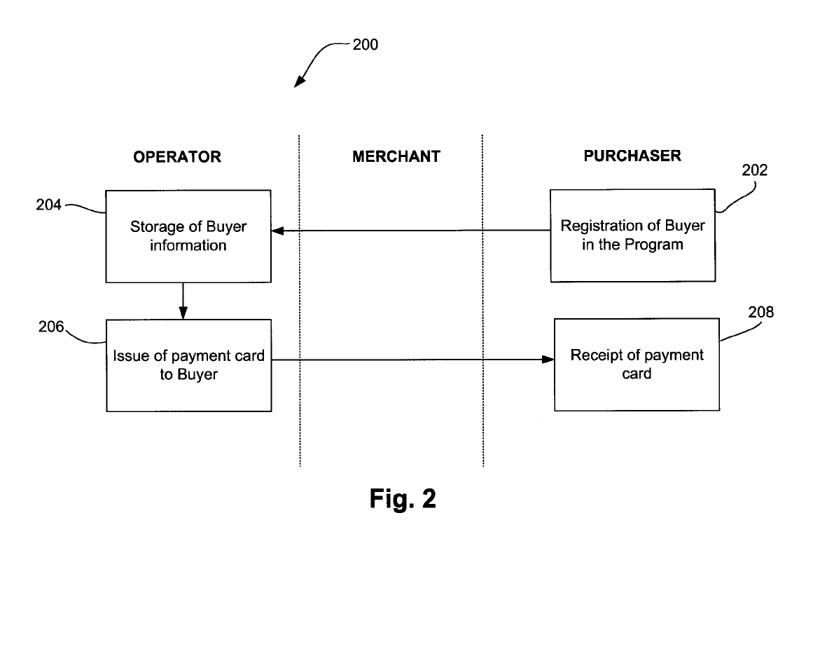

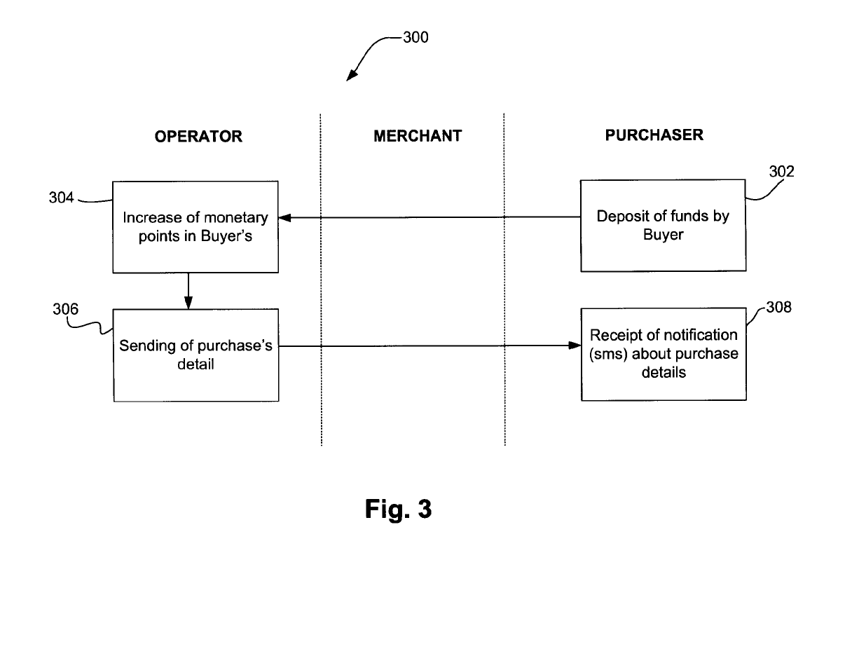

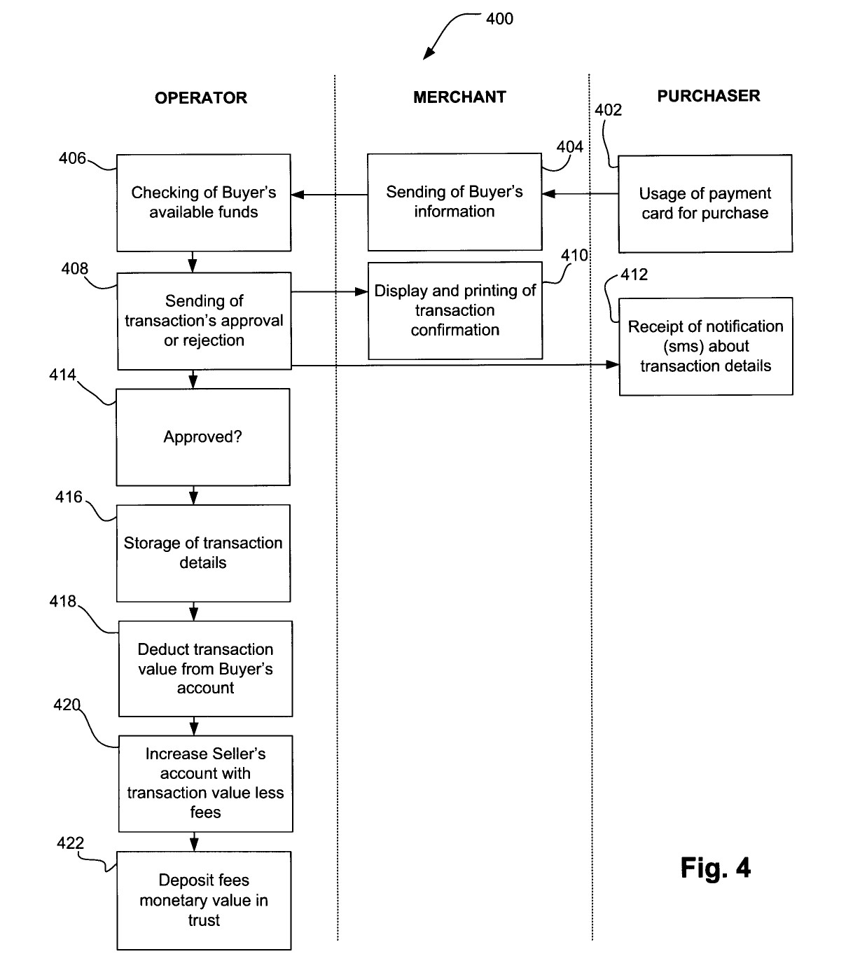

The following steps form part of an example according to an embodiment:
1—Provide the monetary refund facility, thru available technology, such as payment cards, on line transaction, smart phone transactions, etc.
2—Register all buyers/owners of purchasing accounts in the system thru and in a purchasing account identification package, which includes as a minimum, name, account number, nationality, date of birth, gender, profession, address, mobile number, email, ID (identification) number, etc. (see FIG. 2).
3—Create points of sales, either by using available data initiation terminal/merchant terminal and/or introducing new data initiation terminal/merchant terminal belonging exclusively to this application (see FIG. 1).
4—Allow buyers/owners of purchasing accounts to deposit monetary funds in their purchasing account (see FIG. 3).
5—Allow the sales thru the data initiation terminal/merchant terminal in point 3 above (see FIG. 4).
6—Register the details of the purchase, i.e. point of sales, value of purchase, date, time, etc. (see FIG. 4).
7—Segregate the details of the purchase (see FIG. 4).
8—Deduct from the purchasing account of the merchant/seller, in monetary form, certain percentage points of the total sales of the purchase transaction, and deposit the total accumulations of such monetary values of the certain percentage points in a pool of funds (TRUST) (see FIG. 5).
9—Split monetary purchase value of the purchase transaction into merchant's/seller's monetary earnings and the monetary value of the certain percentage points. Transfer merchant's/seller's monetary earnings into his selling account; and deposit the monetary value of the certain percentage points (the fees) in a separate account for the pool of funds (TRUST) belonging to the system operator/developer (see FIG. 5).

### Monetary Refund Mechanism:

According to an embodiment, the refund to eligible purchasers/buyers/purchasing account holders is deposited in the purchasing account of the owner thereof from the monetary funds of given accumulation periods and deposited in the pool of funds (TRUST) is performed as described in the following paragraphs.

The individual refund monetary value of eligible buyers will come from the BALANCE which is defined as being the difference between total deposits (TRUST) and the costs (COST):

BALANCE=TRUST−COST.

The costs include, but are not limited to, operational and management costs, legal expenses like taxes or otherwise, reasonably legal profits and alike. The costs are paid to the operator/developer of the system.

Consequently, the objective of this scheme is to refund the BALANCE to the eligible buyers/purchasing account holders.

The diffusion/attribution will be performed based on time intervals (aka given accumulation period), which can be multiples or fractions of hours, during one calendar day or otherwise. Such criteria can be reconsidered from time to time. Alternatively, the program, or algorithm, can be executed in multiples or fractions of an hour during a calendar day or otherwise within geographical (time) zones on a given territory (e.g., the USA). In other embodiments, it would be applied on a world-wide basis.

According to an embodiment, eligible refund buyers will be the buyers of the first refund time or second refund time of a given refund time in the forward and backward time order according to the relevant time stamp or similar and/or other similar algorithms of similar or distinct time intervals or other applications.

According to an embodiment, refund policy can be subject to change based on holiday period, occasion, and promotional packages.

According to an embodiment, the total diffusion/attribution/refund of each time interval will be made to the number of eligible buyers/purchasing account holders such that the BALANCE in the given refund time interval is zeroed; i.e., if the balance is x dollars and the number of eligible buyers to a refund, or other algorithms, is such that the x dollars is completely diffused as full refund of the transactions, then the total number of the eligible buyers to a refund, or other algorithms, are identified, and accordingly the total number of eligible buyers can be any number such that this number exhausts/diffuses the BALANCE available of the given refund time interval.

The attribution of funds to purchasing account holders is illustrated by the following particular example of the eligible buyers to a refund. If the balance contains $1,000, such balance will be diffused equally between the eligible buyers of the forward time order and the backward time order of a given refund time to a refund associated to a time stamp, 50/50, i.e., $500 to the eligible buyers of the forward time order of a given refund time and $500 to the eligible buyers of the backward time order of a given refund time, such that the first $500 will be diffused to any number of eligible buyers of the forward time order until the first $500 is zeroed, and the second $500 will be diffused to any number of eligible buyers of the backward time order until the $500 is zeroed for the selected given refund time of the interval of time associated to time stamps applicable to this algorithm.

According to an embodiment, the daily transactions information (or at another frequency established by the operator) will be available to the public on a daily basis or otherwise and accessible to everyone thru a dedicated website, social media sites, mobile applications and the like. The transactions information will provide total number and value of purchases showing the progress of accumulation of the BALANCE available for diffusion for each time interval.

According to an embodiment, eligible buyers will be notified of their winnings thru a dedicated website, social media sites, mobile applications, text messages, emails and/or the like upon the completion of the eligibility process. The eligible buyers will be credited the full value of their refunds in their purchasing accounts within the program.

According to an embodiment, the list of actual eligible buyers for each time interval thru any algorithm will be made available thru a dedicated website. The daily transactions information will be available to the public on a daily basis or otherwise, accessible to all thru a dedicated website, social medias, mobile applications and the like. The transaction information will provide total number and value of purchases showing the BALANCE available for diffusion of each time interval.

Now referring to FIG. 1, there is described a process 100 for a merchant's program registration, in accordance with an embodiment. The process 100 comprises the steps of: Registration of the merchant in the program (step 102); Registration of the merchant in the program (step 104); Issue of machines for accepting buyer's payment card (step 106); and Installation of machines at point of sales/data initiation terminal (step 108). Alternatively, machines already in place can be used to accept buyer's payment card.

Now referring to FIG. 2, there is described a process 200 for a buyer's program registration, in accordance with an embodiment. The process 200 comprises the steps of: Registration of buyer in the program (step 202); Storage of buyer information (step 204); Issue of payment card to buyer (step 206); and Receipt of payment card (step 208).

Now referring to FIG. 3, there is described a process 300 for a buyer's deposit of monetary funds in his purchasing account, in accordance with an embodiment. The process 300 comprises the steps of: Deposit of funds by buyer (step 302); Increase of monetary funds in purchasing account (step 304); Sending of deposit's detail (step 306); and Receipt of notification (sms) about deposit details (step 308).

Now referring to FIG. 4, there is described a process 400 for a buyer's purchase transaction, in accordance with an embodiment. The process 400 comprises the steps of: Usage of payment card for purchase (step 402); Sending of buyer information (step 404); Verifying buyer's available funds (step 406); Sending of transaction's approval or rejection (step 408); Display and printing of transaction confirmation (step 410); Receipt of notification (sms) about transaction details (step 412); Confirmation of the approval of the transaction (step 414); Storage of transaction details (step 416); Deduct transaction value from buyer's purchasing account (step 418); Increase Merchant's selling account with transaction value less fees (step 420); Deposit fees monetary value in the operator's/developer's account/pool of funds/TRUST (step 422).

Now referring to FIG. 5, there is described a process 500 for a refund of monetary funds, in accordance with an embodiment. The process 500 comprises the steps of: Ending of fees collection process of given refund time intervals and deposit in the TRUST (step 502); Deduction of COSTS from the TRUST and credit the COSTS to the developer's/operator's account such that TRUST−COST=BALANCE (step 504). The BALANCE is identified as the monetary funds ready to be diffused as refunds to eligible buyers; Execution of algorithm for selection of eligible buyers (step 506); Diffusion of BALANCE into eligible buyers purchasing account (step 508); Notifying eligible buyers of their monetary refund (step 510); Receipt of notification (sms) about monetary refund (step 512); and Publishing on website of time interval's transactions list and diffusion details of monetary refunds (step 514).

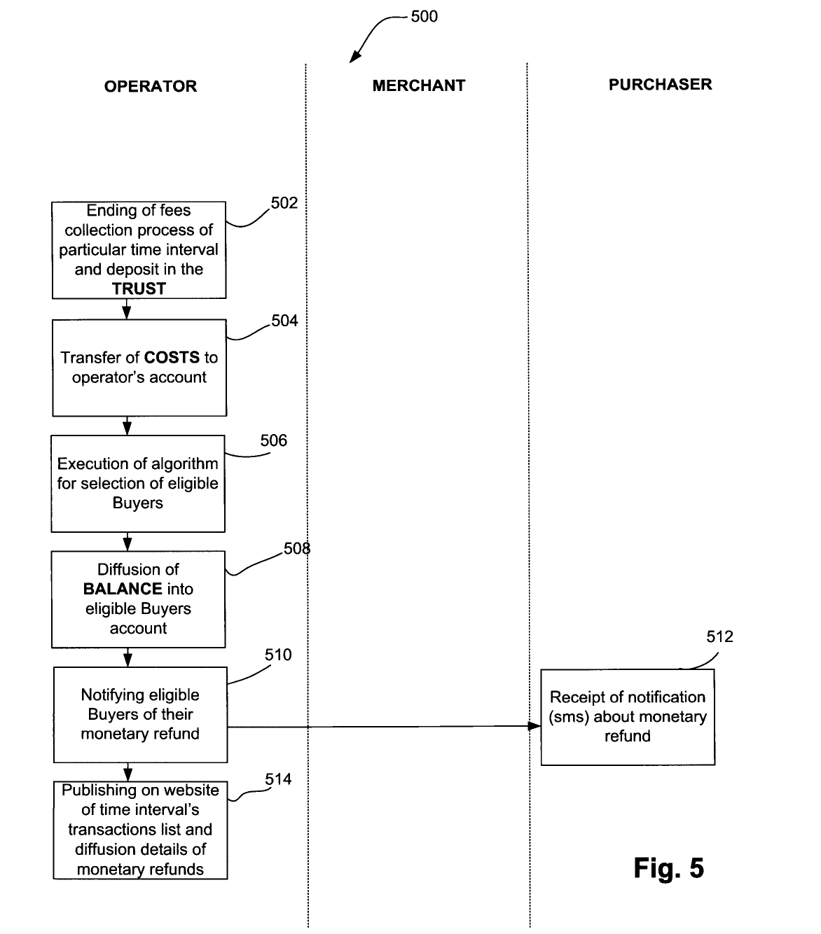

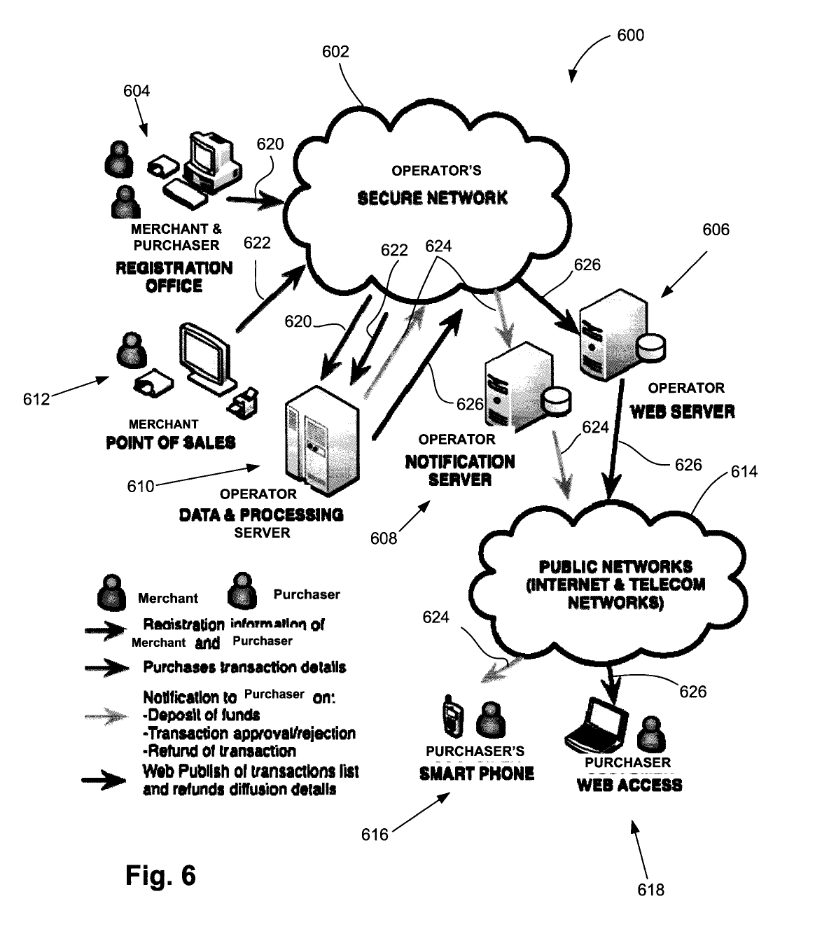

Now referring to FIG. 6, there is described a purchase refund system 600, in accordance with an embodiment. The system 600 comprises a programmer/operator secure network 602 which provides secure communications between:

1—the buyers and merchants registration office 604;

2—the seller's/merchant's point of sales 612;

3—the developer's/operator's data and processing server 610;

4—the developer's/operator's notification server 608; and

5—the developer's/operator's web server 606.

The developer's/operator's notification server 608 and the developer's/operator's web server 606 in turn communicate, thru public networks 614 (such as the internet and telecom networks), with buyer's smart phones 616 and buyer's web access 618 (e.g., web-enabled computing devices).

According to an embodiment, the information which is exchanged within system 600 comprises:

1—registration of information concerning merchants and buyers/purchasers 620;

2—purchase transaction details 622;

3—notifications to buyers concerning deposit of funds;

4—transaction approvals/rejections;

5—refund of transactions 624; and

6—Web publication of transaction lists and refunds diffusion/attribution details 626.

The operator data and processing server 610 is for providing a refund to an eligible purchasing account, in which monetary funds are held, for a purchase made at a purchase price at a specific time to which is associated a time stamp. The operator data and processing server 610 comprises: a memory (not shown) for storing data and instructions; and a processor (not shown) in communication with the memory. The processor is for executing the instructions. The instructions comprise the steps of: receiving a portion of the purchase price in a pool of funds, defined as a trust; and determining the refund to be transferred from the trust to the eligible purchasing account based on the time stamp, the refund covering at least a part of or, on given occasions, a multiple of the purchase price. According to separate and distinct embodiments, the instructions also include the other steps, in combination or individually, of the method for providing a refund described herein.

The following paragraphs list advantages of the presently described system and method:
1—All payment cards, which provide rewards like loyalty points and cashbacks, do not refund the full monetary value and the possibility of the multiples of the value of a purchase transaction. The scheme described herein does provide such a refund.
2—The scheme described herein provides the refund of the full monetary value of a purchase transaction and, in given occasions, opportunities of multiples of the full monetary value of a transaction.
3—The refund of the scheme described herein can be used in the acquisition of ANY consumer commodity from ANY supplier within the refund limit, unconditionally, without restrictions on using the refund at the same merchant terminal where the purchase eligible for refund was made.
4—The process is a straightforward user-friendly program.
5—The selection of eligible buyers can be made based on a simple algorithm or randomly.
6—The scheme described herein does not limit the value of a particular purchase transaction, as such a purchase transaction can be refunded from the available funds in the BALANCE corresponding to the given refund time, when the particular transaction is performed in the event that the available funds in the balance are at least sufficient to refund the value of the particular purchase transaction and, if not, a part of the transaction such that the BALANCE is zeroed and/or diffused in full.
7—The scheme described herein is applicable with all merchants/sellers and the rewards are paid from the BALANCE and not from the particular merchants/sellers.
8—The scheme described herein is a continuous process.
9—The permutation of the scheme described herein is performed on the basis of complete hours or fraction of these hours or otherwise.
10—The scheme described herein displays, on the web, the progress of the BALANCE collected for diffusion of refund and the progress of diffusion.
11—The scheme described herein displays the number of eligible buyers and the respective refunds of every eligible buyer for a given refund time.
12—The scheme described herein can accommodate virtual accounts, which can be linked to an existing purchasing account, to allow the buyer to participate in the program.
13—The scheme described herein can accommodate all forms of payments, such as, for example, payment cards, wire transfers, online payments, check deposits, etc.
14—The scheme described herein can be versatile and used for detailed data collection for various applications and promotions of different merchants/sellers of the components of the detailed collected data.
15—The scheme described herein can create point of sales, either by using available data initiation terminal/merchant terminal and/or introducing new data initiation terminal/merchant terminal belonging exclusively to this application.
16—Regardless of the credit standing of the buyer, a person is an eligible buyer since he is depositing funds (monetary funds) in his purchasing account.
17—The scheme described herein is versatile and enables the launching of particular rewards on a time-to-time basis and particular occasions. For example, the accumulation of a certain portion of the BALANCE to release it in a one-shot or surprise refund on a given occasion like Valentine's Day.
18—The scheme described herein is applicable to all kinds of consumer commodities.
19—The scheme described herein can be elaborated to monitor the consumption of different consumer commodities. The information can then be communicated/transmitted back officially to interested parties with the objective of enhancing the interest of all related parties.

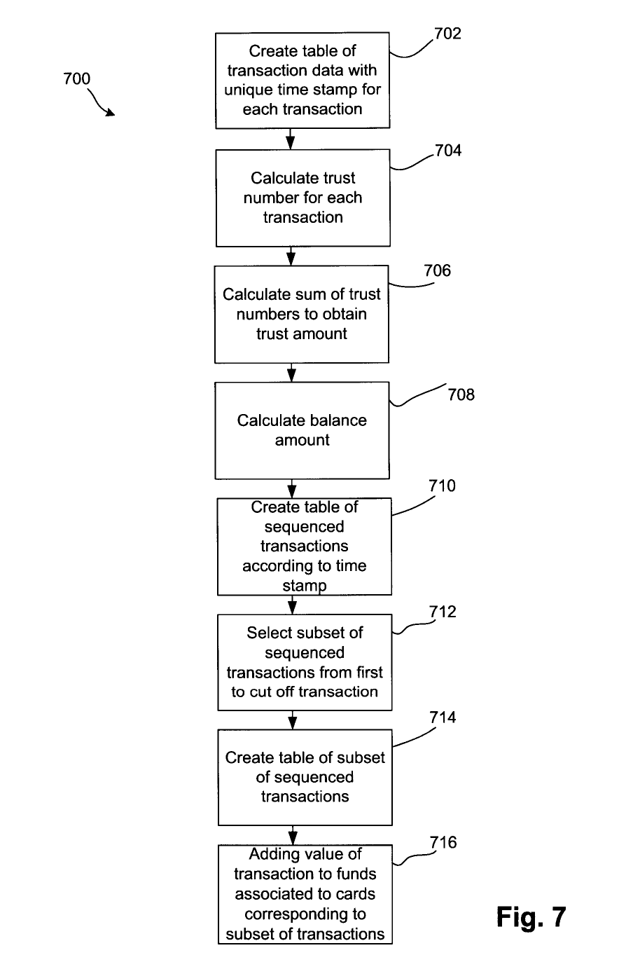

Now turning to FIG. 7, a method 700 for automatically and/or systematically transferring, storing and exchanging funds data between payment cards, merchant terminals and an operator database according to an embodiment is disclosed. It should be noted that the funds data concern transactions performed using the payment cards and that each one of the payment cards has associated thereto a card ID (identification), a payment card account and an amount of funds available for performing transactions,

The method 700 is implemented on an operator data and processing server (see FIG. 6) which performs the steps detailed below.

In step 702, a table of transaction data is created in the operator database. The transaction data results from the use of a plurality of the payment cards at at least one of the merchant terminals which generates the transaction data. The transaction data includes, for each use, a transaction ID (identification), the respective card ID, a number representative of the value of the transaction and a unique time stamp representative of a specific time at which the use took place. According to an embodiment, the use takes place within a given accumulation period which comprises multiples or fractions of hours during one calendar day. In this example of the table of transaction data, the transaction ID is the unique key that is used to ensure each transaction is uniquely identified.

According to an embodiment, the details of the purchased item and associated data form part of the transaction data stored in the operator database.

In step 704, trust numbers are calculated by applying a percentage that is less than 100% to each number representative of the value of the transaction.

In step 706, all the trust numbers within the given accumulation period are summed thereby defining a trust account amount.

In step 708, a balance amount is calculated by applying a percentage that less than 100% to the trust account amount.

In step 710, a table of sequenced transactions by transaction ID is created in the operator database. The sequenced transactions is ordered according to their respective unique time stamp within the given accumulation period. As for the table of transaction data, the unique key for the table of sequenced transactions is the transaction ID according to an embodiment.

In step 712, a subset of the sequenced transactions is selected. The subset is selected starting from a first transaction in the sequenced transactions, the first transaction being the most cotemporal to the given time, and ending with a cut off transaction which is the transaction where the sum of all the numbers representative of the value of transactions, for the transactions between and including the first and at least a portion of the cut off transaction, is equal to or more than the balance amount.

In step 714, a table of the subset of the sequenced transactions is created in the operator database. The table of the subset of the sequenced transactions comprises the transaction IDs and the corresponding number representative of the value of transactions for each transaction of the subset of the sequenced transactions. As for the table of transaction data, the unique key for the table of the subset of the sequenced transactions is the transaction ID according to an embodiment.

In step 716, the corresponding numbers representative of the value of the transaction are respectively added to the amount of funds associated to the payment cards which correspond to the transactions in the subset of the sequenced transactions within the given accumulation period.

According to an embodiment, the steps of selecting a subset of the sequenced transactions (step 712), creating a table of the subset of the sequenced transactions in the operator database (step 714) and respectively adding each corresponding number representative of the value of the transaction to the amount of funds associated to the payment cards which correspond to the transactions in the subset of the sequenced transactions (step 716) are performed after the given accumulation period.

According to an embodiment, the steps which are performed after the given accumulation period (e.g., step 712, 714 and 716) are performed in less than 5 minutes. According to an embodiment, the steps which are performed after the given accumulation period (e.g., step 712, 714 and 716) are performed in less than 1 minute. According to an embodiment, the steps which are performed after the given accumulation period (e.g., step 712, 714 and 716) are performed in less than 10 seconds. According to an embodiment, the steps which are performed after the given accumulation period (e.g., step 712, 714 and 716) are performed in less than 1 second. According to an embodiment all steps of the method performed after the given accumulation period are performed according to the periods set out above. According to an embodiment all steps of the method are performed according to the periods set out above.

According to an embodiment, the number of transactions involved in the steps of the method within a given accumulation period is more than 3600. According to an embodiment, the number of transactions involved in the steps of the method within a given accumulation period is more than 10,000. According to an embodiment, the number of transactions involved in the steps of the method within a given accumulation period is more than 100,000. According to an embodiment, the number of transactions involved in the steps of the method within a given accumulation period is more than 1,000,000.

According to an embodiment, the rate of transactions involved in the steps of the method is more than 1 per second. According to an embodiment, the rate of transactions involved in the steps of the method is more than 10 per second. According to an embodiment, the rate of transactions involved in the steps of the method is more than 100 per second. According to an embodiment, the rate of transactions involved in the steps of the method is more than 1,000 per second.

According to an embodiment, the foregoing steps performed by the operator data and processing server are performed without human intervention. By performing the steps disclosed herein, the operator data and processing server becomes a special purpose server; i.e., one performing functions which no other server has performed before. The operator data and processing server is therefore essential to the method described herein.

According to an embodiment, the performance of the method by the operator data and processing server covers a particular application of the addition of the value of a transaction to the amount of funds associated to the payment cards which correspond to the transactions in the subset of the sequenced transactions. According to another embodiment, the performance of the method by the operator data and processing server covers a particular application of a method of processing a refund.

Furthermore, because of time constraints and the number of operations involved in performing the method for a high volume of transactions, it would neither be useful nor practical to perform steps by a person or a team of persons however large the team would be. The shear coordination problem related to updating the tables of data, calculating, summing and updating the amount of funds associated to the payment cards would render the task impossible.

According to an embodiment, the selecting of the subset comprises selecting sequenced transactions according to at least one of: a forward time order of the purchases; and a backward time order of the purchases.

According to an embodiment, the given time comprises a first time and a second time, wherein a first portion of the balance amount is attributed to a period starting from the first time and a second portion of the balance is attributed to a period starting from the second time.

According to an embodiment, a first portion of the balance is used in the adding step from the first time according to a forward time order and a second portion of the balance is used in the adding step from the second time according to a backward time order.

According to an embodiment, the first time corresponds to a beginning of the given accumulation period and the second time corresponds to an end of the given accumulation period.

According to an embodiment, the first portion of the balance amount and the second portion of the balance amount are equal.

According to an embodiment, the method further comprises remotely accessing, for each one of the payment cards, the payment card account for recording and validating the amount of funds available for performing transactions.

According to an embodiment, the method further comprises adding the trust account amount of each accumulation period to a trust account. The trust account is separate and distinct from the payment card account and is inaccessible by a user having access to the payment card account.

According to an embodiment, the method further comprises, before adding the corresponding numbers representative of the value of the transaction to the amount of funds associated to the payment cards, identifying, based on the transaction ID key in the table of transaction data, the respective card IDs and the associated amount of funds available for performing transactions.

According to an embodiment, the method further comprises receiving from a plurality of the merchant terminals the transaction data over a secure communication network.

According to an embodiment, the method further comprises associating the respective card IDs to respective users having previously associated an address of a computing device to the respective user and sending a notification to the computing devices advising the respective users that the adding the corresponding numbers representative of the value of the transaction to the amount of funds associated to the payment cards took place.

According to an embodiment, the given accumulation period comprises multiples or fractions of hours during one calendar day

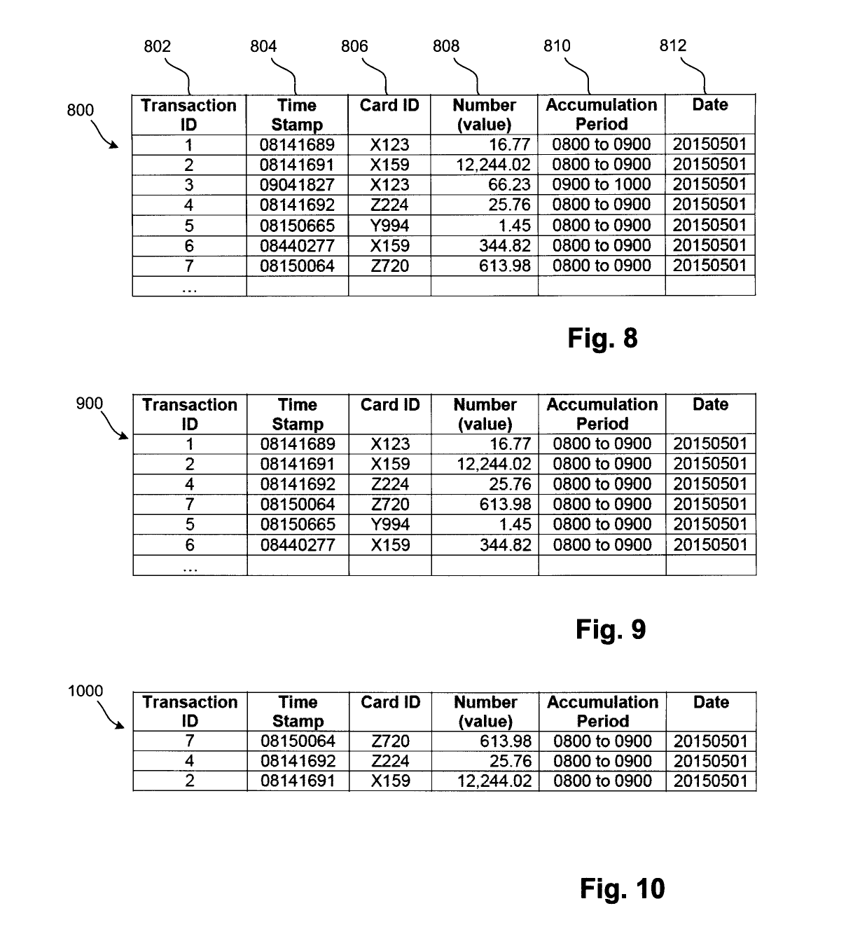

Now turning to FIGS. 8, 9 and 10, a transaction data table 800, sequenced transactions table 900 and a subset of the sequenced transactions table 1000 are respectively shown. According to an embodiment, the foregoing tables are created in the operator database (not shown) which is part of, or at least in communication with, the operator data and processing server (see FIG. 6).

According to an embodiment, the transaction data table 800, sequenced transactions table 900 and a subset of the sequenced transactions table 1000 all have the same columns: Transaction ID column 802, Time Stamp column 804, Card ID column 806, Number (value) column 808 (e.g., dollars), Accumulation Period column 810 (e.g., one hour periods) and Date column 812 (e.g., yyyymmdd).

As stated earlier the transaction data table 800 results from the use of a plurality of the payment cards at at least one of the merchant terminals which generates the transaction data. In this example, the transactions are in no particular order. Transaction ID 1 and 3 are performed using the same Card ID (X123) within two distinct Accumulation Periods on the same Date and at distinct and/or at the same merchant terminals.

The sequenced transactions table 900 shows that the transactions are reordered (i.e., sequenced) according to their respective time stamp within a given accumulation period. Accordingly, the date of the transactions is also used when reordering the transactions. In this example, all transactions are performed on the same date. This example now shows that the transaction sequence with a given accumulation period (e.g., 0800 to 0900 which represents 8 am to 9 pm on May 1, 2015) is 1, 2, 4, 7, 5, 6. Transaction 3 is not in the list since it occurs in a different given accumulation period.

The subset of the sequenced transactions table 1000 shows that only three transactions (7, 4 and 2) remain. In this example, the given time is 0815 and the balance amount is calculated to be 4,912.74 in view of all the transactions made during the accumulation period. This exemplary balance amount (4,912.74) is obtained from the trust which is generated by applying a certain percentage, say 4%, on a hypothetical value of 205,072.50 being the sum of the value of transactions within a given accumulation period (i.e., the sum of all the numbers representative of the value of the transactions within a given accumulation period) yielding a value of the trust equal to 8,202.90 to which another percentage is applied, in this case 60%, to generate the balance which in this case becomes 4,921.74.

The transactions are first reordered (re-sequenced) starting with the transaction ID which is most cotemporal to the given time. In this case, transaction ID 7 is the most cotemporal to 0815. The next is transaction ID 4 and then transaction ID 2. The next one would have been transaction ID 1 which took place 2 ms before transaction ID 2 and therefore is less cotemporal to 0815. The cut off transaction is identified in this example as being transaction ID 2 since it is the transaction where the sum of all the numbers representative of the value of transactions, for the transactions between and including the first and at least a portion of the cut off transaction (i.e., 613.98+25.76+12,244.02=12,883.76), is equal to or more than the balance amount (i.e., 4,912.74).

According to other embodiments, supplementary criteria are added to reorder the transactions. The supplementary criteria could be to limit the reordered transactions to those which are after the given time or, alternatively, to those which precede the given time.

This example further shows that the value of the transaction which are respectively added to the amount of funds associated to the payment cards which correspond to the transactions in the subset of the sequenced transactions are as follows: “613.98” is added to the amount of funds in the account associated with payment card Z730; “25.76” is added to the amount of funds in the account associated with payment card Z224; and “4,273.00” is added to the amount of funds in the account associated with payment card X159. In this example, 4,273.00 is the amount which remains from the balance amount once the first two additions to the amounts of funds in the accounts associated with payment cards Z730 and Z224 are performed (i.e., 4,912.74−613.98−25.76=4,273.00). Therefore, for the cut off transaction, 7,971.02 of the 12,244.02 will remain unpaid.

While preferred embodiments have been described above and illustrated in the accompanying drawings, it will be evident to those skilled in the art that modifications may be made without departing from the concept and method of this disclosure. Such modifications are considered as possible variants comprised in the concept and method of this disclosure.

1. A method for transferring funds data related to transactions performed using payment cards at merchant terminals, each one of the payment cards having associated thereto a card ID, a payment card account and an amount of funds available for performing transactions, the method implemented on an operator data and processing server which performs the following steps:
creating a table of transaction data in an operator database, the transaction data resulting from the use of a plurality of the payment cards at merchant terminals in a transaction which generates the transaction data including, for each use, a transaction ID, the card ID, a number representative of the value of the transaction and a unique time stamp representative of a specific time at which the use took place, wherein the use takes place within a given accumulation period;
calculating trust numbers by applying a percentage that is less than 100% to each number representative of the value of the transaction;
summing all the trust numbers within the given accumulation period thereby defining a trust account amount;
calculating a balance amount by applying a percentage that less than 100% to the trust account amount;
creating a table of sequenced transactions by transaction ID in the operator database, the sequenced transactions being ordered according to their respective unique time stamp within the given accumulation period;
selecting a subset of the sequenced transactions by transaction ID, the subset being selected starting from a first transaction in the sequenced transactions, the first transaction being the most cotemporal to a given time, and ending with a cut off transaction which is the transaction where a sum of each number representative of the value of the transactions, for the transactions between and including the first and at least a portion of the cut off transaction, is equal to or more than the balance amount;
creating a table of the subset of the sequenced transactions in the operator database, the table of the subset of the sequenced transactions comprising the transaction ID and a corresponding number representative of the value of transactions for each transaction of the subset of the sequenced transactions;
respectively adding each corresponding number representative of the value of the transaction to the amount of funds associated to the payment cards which correspond to the transactions in the subset of the sequenced transactions.

2. The method of claim 1, wherein the selecting of the subset comprises selecting sequenced transactions according to at least one of:
a forward time order of the transactions; and
a backward time order of the transactions.

3. The method of claim 2, wherein the given time comprises a first time and a second time, wherein a first portion of the balance amount is attributed to a period starting from the first time and a second portion of the balance amount is attributed to a period starting from the second time.

4. The method of claim 3, wherein a first portion of the balance amount is used in the adding step from the first time according to a forward time order and a second portion of the balance amount is used in the adding step from the second time according to a backward time order.

5. The method of claim 4, wherein the first time corresponds to a beginning of the given accumulation period and the second time corresponds to an end of the given accumulation period.

6. The method of claim 5, wherein the first portion of the balance amount and the second portion of the balance amount are equal.

7. The method of claim 1, further comprising remotely accessing, for each one of the payment cards, the payment card account for recording and validating the amount of funds available for performing transactions.

8. The method of claim 7, further comprising adding the trust account amount to a trust account, the trust account being separate and distinct from the payment card account and being inaccessible by a user having access to the payment card account.

9. The method of claim 8, further comprising, before adding the corresponding numbers representative of the value of the transaction to the amount of funds associated to the payment cards, identifying, based on the transaction ID in the table of transaction data, the respective card IDs and the amount of funds available for performing transactions associated to the transaction ID.

10. The method of claim 9, further comprising receiving from a plurality of the merchant terminals the transaction data over a secure communication network.

11. The method of claim 1, further comprising associating the respective card IDs to respective users having previously associated an address of respective computing devices to the respective users and sending a notification to the respective computing devices advising the respective users that the adding the corresponding numbers representative of the value of the transactions to the amount of funds associated to the payment cards took place.

12. A method for providing refunds to eligible purchasing accounts, in which monetary funds are respectively held, for purchases made at respective purchase prices at respective merchant terminals at respective specific times to which are associated respective time stamps, the method comprising:
at an operator data and processing server, receiving a portion of the respective purchase prices for purchases made during a given accumulation period using the plurality of eligible purchasing accounts, in a pool of funds defined as a trust, wherein the portion of the respective purchase prices is less than the respective purchase prices, wherein the given accumulation period comprises multiples or fractions of hours during one calendar day; and
the operator data and processing server selecting, from the purchases made, the refunds to be credited from the trust to the eligible purchasing accounts based on the respective time stamps, wherein the trust comprises funds for fully refunding the purchase price of at least one of the purchases starting from a given refund time within the given accumulation period, wherein the refunds are for use for other purchases without restrictions, and further wherein the selecting, from purchases made, results in fully refunding a number of purchases which is less than the total number of purchases made.

13. The method according to claim 12, further comprising determining a total refund amount, defined as a balance, as being at least a portion of the funds in the trust, wherein the purchases are sequenced according to the respective time stamps associated thereto thereby defining sequenced purchases and further wherein the selecting the refunds comprises selecting the refunds to eligible purchasing accounts for the sequenced purchases starting from a given refund time comprised within the given accumulation period until the balance is completely diffused.

14. The method according to claim 13, further comprising using the operator data and processing server for crediting the refunds from the balance to the eligible purchasing accounts.

15. The method according to claim 14, wherein the selecting the refunds comprises selecting the refunds to eligible purchasing accounts for the sequenced purchases starting from a given refund time until the balance is completely diffused according to at least one of:
a forward time order of the purchases; and
a backward time order of the purchases.

16. The method according to claim 14, wherein the given refund time comprises a first refund time and a second refund time, wherein a first portion of the balance is determined from the first refund time and a second portion of the balance is determined from the second refund time.

17. The method according to claim 16, wherein a first portion of the balance is determined from the first refund time according to a forward time order and a second portion of the balance is determined from the second refund time according to a backward time order.

18. The method according to claim 17, wherein the first refund time corresponds to a beginning of the given accumulation period and the second refund time corresponds to an end of the given accumulation period.

19. The method according to claim 18, wherein the first portion of the balance and the second portion of the balance are equal.

20. The method according to claim 12, wherein the selecting the refunds comprises selecting the refunds to eligible purchasing accounts which are one of:
equal to the purchases; or
on given occasions, a multiple of the purchases.

21. The method according to claim 12, further comprising creating eligible purchasing accounts and attributing an owner to a respective one of the eligible purchasing accounts.

22. The method according to claim 12, further comprising sending a confirmation to a network access device used that a refund is credited to the eligible purchasing account associated with the network access device.

23. The method according to claim 12, wherein the selecting the refunds comprises selecting a one shot or surprise refund on a given occasion.

24. The method according to claim 12, further comprising crediting the refunds from the trust to the eligible purchasing account.

25. An operator data and processing server for providing refunds to eligible purchasing accounts, in which monetary funds are held, for purchases made at respective purchase prices at respective merchant terminals at respective specific times to which are associated respective time stamps, the operator data and processing server comprising:
a memory for storing instructions; and
a processor in communication with the memory, the processor for executing the instructions, wherein the instructions comprise the steps of:
receiving a portion of the respective purchase prices for purchases made during a given accumulation period using the plurality of eligible purchasing accounts, in a pool of funds defined as a trust, wherein the portion of the respective purchase prices is less than the respective purchase prices, wherein the given accumulation period comprises multiples or fractions of hours during one calendar day; and
selecting, from the purchases made, the refunds to be credited from the trust to the eligible purchasing accounts based on the respective time stamps, wherein the trust comprises funds for fully refunding the purchase price of at least one of the purchases starting from a given refund time within the given accumulation period, wherein the refunds are for use for other purchases without restrictions, and further wherein the selecting, from purchases made, results in fully refunding a number of purchases which is less than the total number of purchases made.

26. An operator data and processing server for transferring funds data related to transactions performed using payment cards at merchant terminals, each one of the payment cards having associated thereto a card ID, a payment card account and an amount of funds available for performing transactions, the operator data and processing server comprising:
a memory for storing instructions;
an operator database; and
a processor in communication with the memory, the processor for executing the instructions, wherein the instructions comprise the steps of:
creating a table of transaction data in the operator database, the transaction data resulting from the use of a plurality of the payment cards at merchant terminals in a transaction which generates the transaction data including, for each use, a transaction ID, the card ID, a number representative of the value of the transaction and a unique time stamp representative of a specific time at which the use took place, wherein the use takes place within a given accumulation period;
calculating trust numbers by applying a percentage that is less than 100% to each number representative of the value of the transaction;
summing all the trust numbers within the given accumulation period thereby defining a trust account amount;
calculating a balance amount by applying a percentage that less than 100% to the trust account amount;
creating a table of sequenced transactions by transaction ID in the operator database, the sequenced transactions being ordered according to their respective unique time stamp within the given accumulation period;
selecting a subset of the sequenced transactions by transaction ID, the subset being selected starting from a first transaction in the sequenced transactions, the first transaction being the most cotemporal to a given time, and ending with a cut off transaction which is the transaction where a sum of each number representative of the value of the transactions, for the transactions between and including the first and at least a portion of the cut off transaction, is equal to or more than the balance amount;
creating a table of the subset of the sequenced transactions in the operator database, the table of the subset of the sequenced transactions comprising the transaction ID and a corresponding number representative of the value of transactions for each transaction of the subset of the sequenced transactions;
respectively adding each corresponding number representative of the value of the transaction to the amount of funds associated to the payment cards which correspond to the transactions in the subset of the sequenced transactions.
